(19) United States
(12) Patent Application Publication
(10) Pub. No.: US 2017/0355248 A1
(43) Pub. Date: Dec. 14, 2017

(54) PROTECTION DEVICE FOR THE PASSENGER COMPARTMENT OF A VEHICLE

(71) Applicant: BOS GMBH & CO. KG, Ostfildern (DE)

(72) Inventors: Herbert WALTER, Ebersbach (DE); Huan TRAN, Ostfildern (DE); Matthias MAIER, Esslingen (DE)

(21) Appl. No.: 15/535,925

(22) PCT Filed: Nov. 11, 2015
(86) PCT No.: PCT/EP2015/076294

§ 371 Date: Jun. 14, 2017

(30) Foreign Application Priority Data
Dec. 15, 2014 (DE) 10 2014 225 895.2

(51) Int. Cl. B60J 1/20

(52) U.S. Cl. CPC B60J 1/2052; B60J 1/2044; B60J 1/2025; B60J 1/2066

(57) ABSTRACT

A protection device for a vehicle interior compartment including a flexible planar structure displaceable between a pulled-out protective position and a rest position. The planar structure is connected to a dimensionally stable pull-out profile, which profile is mounted for longitudinal displacement on each of its opposite sides in a respective guiding structure fixed to the vehicle. A respective cable pull is installed in each guiding structure, each cable pull engaging on a respective one of sliding bodies slidingly mounted in the guiding structure. The sliding body is connected to the pull-out profile such that a torque introduced into the pull-out profile by the cable pull on the sliding body and a counter-torque introduced into the pull-out profile by the planar structure are configured, relative to a longitudinal axis of the pull-out profile extending transversely to the pull-out direction, such that the sliding bodies and the pull-out profile are held in equilibrium during a displacement move.

The invention relates to a protection device for a vehicle interior compartment, comprising a flexible planar structure which is displaceable between a pulled-out protective position and a rest position, wherein the planar structure is connected to a dimensionally stable pull-out profile on a face end region that is in front in the pull-out direction, which profile is mounted for longitudinal displacement on each of its opposite sides in a respective guiding structure disposed fixed to the vehicle in the ready-for-use condition.

Such a protection device in the form of a shading device for a rear window of a passenger vehicle is disclosed in EP 1 215 063 A1. The known shading device includes a flexible fabric which is held on a roller blind shaft for winding up and off. The roller blind shaft is disposed fixed to the interior below a rear shelf of the vehicle interior and mounted for rotation. The flexible fabric can be pulled-out upwards through a passage slot in the rear shelf and has a dimensionally stable pull-out profile on a face end region that is in front in the pull-out direction, which profile is guided in lateral guiding rails fixed on the vehicle interior side for lengthwise displacement. For that purpose, the pull-out profile is connected, on each of its opposite face ends, with a respective slider block which is mounted for longitudinal displacement in the respective guiding rail. Each slider block is connected to a drive transmission means in the form of a flexshaft which likewise extends within the guiding rail. The two flexshafts in the opposite guiding rails are driven synchronously by an electric motor, in order to achieve parallel displacement of the pull-out profile between a rest position of the fabric and a pulled-out protective position of the fabric.

An object of the invention is to provide a protection device of the type mentioned in the introduction, which allows low-friction displacement of the pull-out profile within the guiding structures.

This object is achieved in that a respective cable pull is installed in each guiding structure, each cable pull engaging on a respective one of sliding bodies slidingly mounted in the guiding structure, which sliding body is connected to the pull-out profile such that a torque introduced into the pull-out profile by a point of application of the cable pull on the sliding body and a counter-torque introduced into the pull-out profile by the planar structure are configured, relative to a longitudinal axis of the pull-out profile extending transversely to the pull-out direction, such that the sliding bodies and the pull-out profile are held in equilibrium during a displacement move. The respective cable pull is installed for low friction in the respective guiding structure so that a movement of the cable pull occurs without great frictional forces between the guiding structure and the respective cable pull. In order to prevent that the planar structure engaging on the pull-out profile applies a tilting effect on the respective sliding body within the respective guiding structure, which would increase friction of the sliding body in a corresponding guiding track of the respective guiding structure, it is provided according to the invention that the cable pull engages on the sliding body in such a manner that said tilting effect introduced by the tensile stress of the planar structure into the pull-out profile and, thus, into the sliding body is compensated. There is no need for complete neutralization of the torques. The compensation of the counteracting torques should merely be configured such that tipping of the sliding body within the guiding structure is prevented, which would result in increased friction between sliding body and guiding structure during a longitudinal displacement of the sliding body. The solution according to the invention is with particular advantage adapted to an employment of the protection device as a shading device for a rear window of a passenger vehicle. Similarly, the protection device can also be provided for shading of side window panes or for shading of transparent roof portions of the vehicle interior. The solution according to the invention is also provided for loading compartment covering or loading compartment partitioning, in order to cover a loading compartment against curious eyes from the exterior using a corresponding flexible planar structure, or in order to obtain an approximately vertical partition of a passenger compartment from the loading compartment.

In an embodiment of the invention, the cable pull includes an open cable which is connected to the sliding body on one end thereof and to a rotatable cable drum on an opposite end thereof. The design of the cable pull as an open cable allows engagement of the cable end of the cable on the sliding body off-center, i.e., eccentric, in relation to an imaginary tilting axis, in a particularly simple manner.

In a further embodiment of the invention, each cable pull is associated with a cable length compensation unit. The cable length compensation unit can be provided by a torsion spring in the region of the cable drum, in order to achieve permanent pre-tensioning for the cable drum, to hold the cable pull tensioned, regardless of a cable lengthening or a cable length wound up or wound off the cable drum and the cable looping, respectively. Instead of a torsion spring, likewise a tension spring or compression spring can be provided for cable length compensation. As an alternative, it is possible to install the cable of the cable pull in a Bowden cable device which is curved and, consequently, compensating corresponding cable length differences or tension force variations of the cable pull.

In a further embodiment of the invention, each guiding structure is provided, on its end region remote from the cable drum, with a deflection guide designed in the form of a circular arc-shaped sliding guide for the cable. The circular arc-shaped sliding guide is particularly simple to produce. Surprisingly, the circular arc shape of the sliding guide has proved to be particularly appropriate to deflect the cable with low friction.

In a further embodiment of the invention, the cable is guided along the guiding structure over a plurality of transverse clamp supports which cause combined guiding and transverse clamping of the cable relative to the running direction thereof. As a result, a so-called guitar strings effect is prevented with the cable in a condition installed lengthwise of the guiding structure and ready-for-use under tensile loading, i.e., longitudinal vibrations of the cable during operation of the cable pull are prevented. The transverse clamp supports ensure that the cable remains in the predefined guiding tracks within the guiding structure, without getting caught or jammed.

Further advantages and features of the invention will become apparent from the claims and from the description below of a preferred exemplary embodiment of the invention which is illustrated with reference to the drawings.

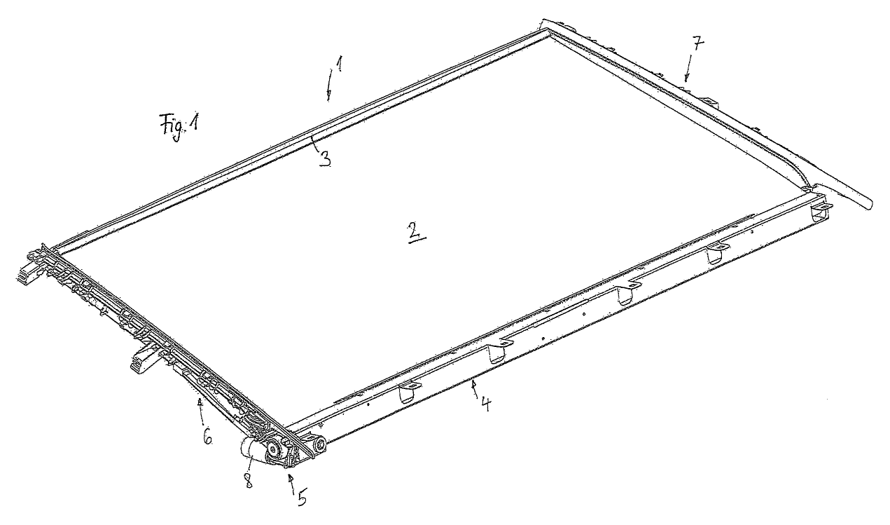

FIG. 1 shows a perspective view of an embodiment of a protection device according to the invention in the form of a shading device for a rear window of a passenger vehicle;

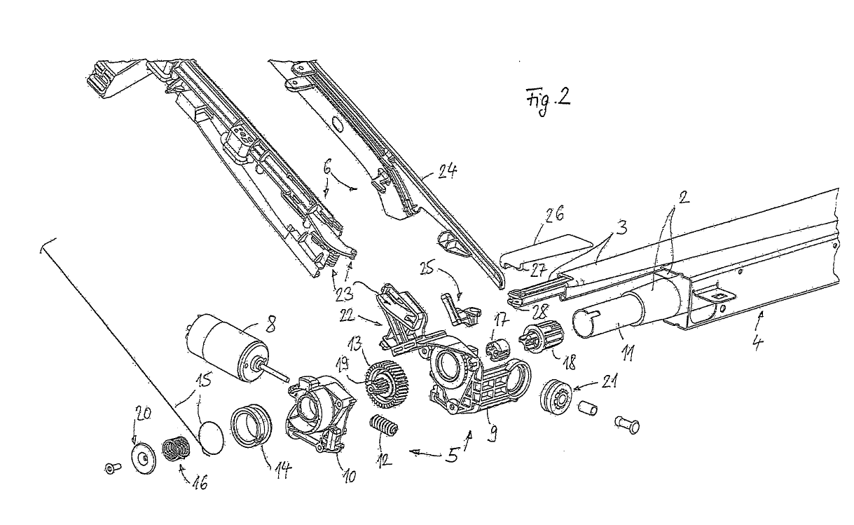

FIG. 2 shows an exploded view of a left-hand side of the shading device according to FIG. 1;

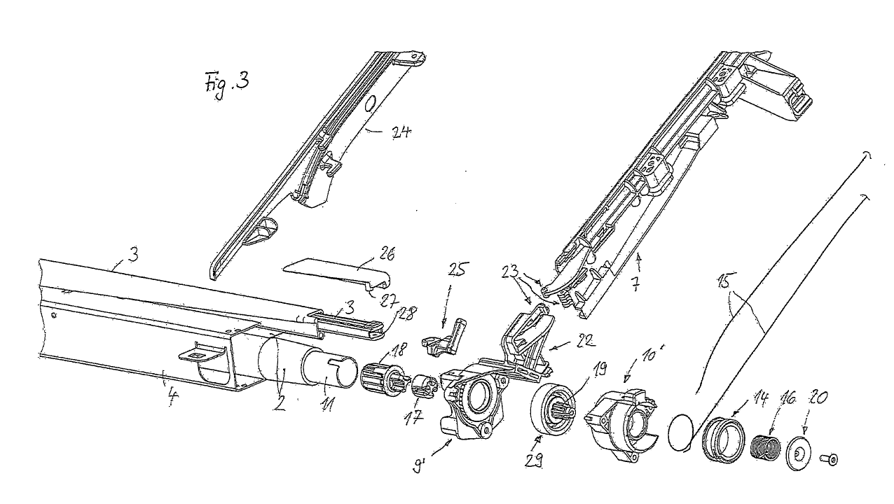

FIG. 3 shows an exploded view of a right-hand side of the shading device according to FIG. 1;

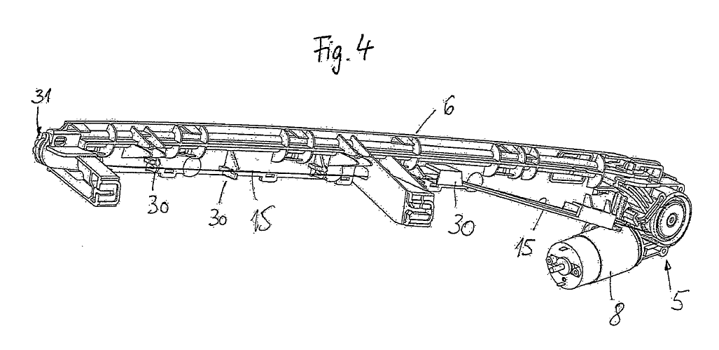

FIG. 4 shows a guiding structure on the drive side of the shading device according to FIG. 1;

FIG. 5 shows an enlarged perspective view of a section of a drive side of the shading device according to FIGS. 1 to 4;

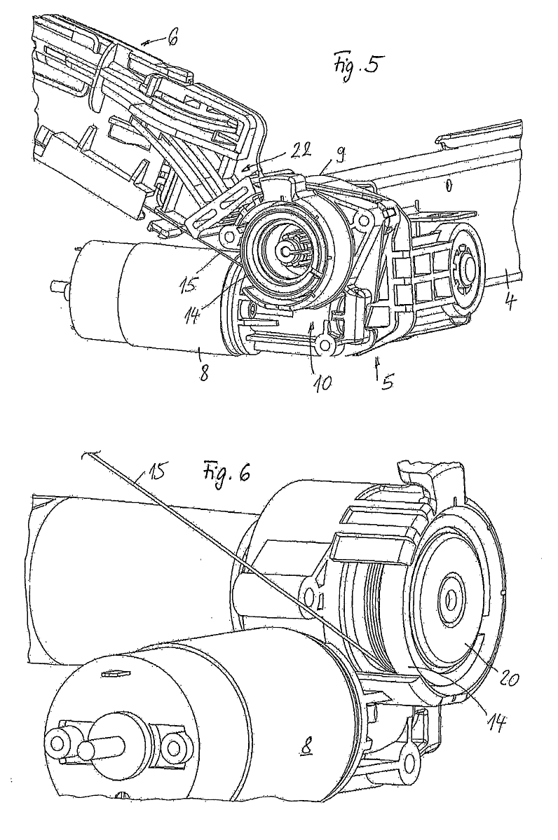

FIG. 6 shows a further enlarged perspective view of a drive system of the shading device according to FIGS. 1 to 5 with the guiding structure on the drive side omitted;

FIG. 7 shows a perspective view of a part of the guiding structure for the shading device according to FIGS. 1 to 5;

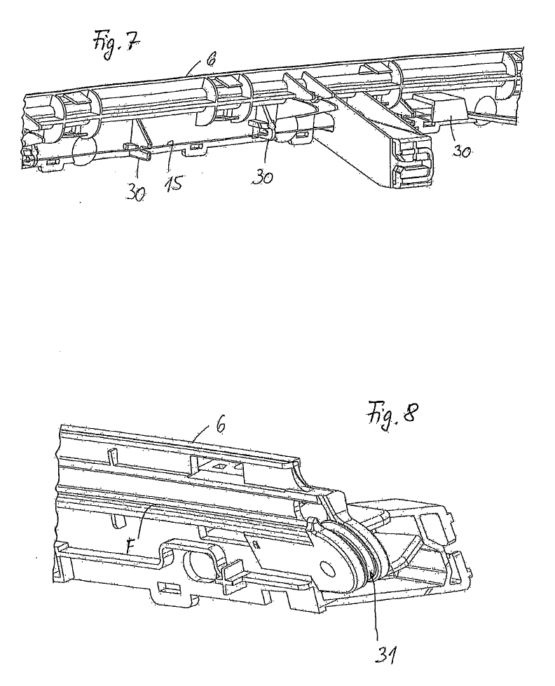

FIG. 8 shows a further part of the guiding structure for the shading device according to FIGS. 1 to 7 in the region of a cable deflection;

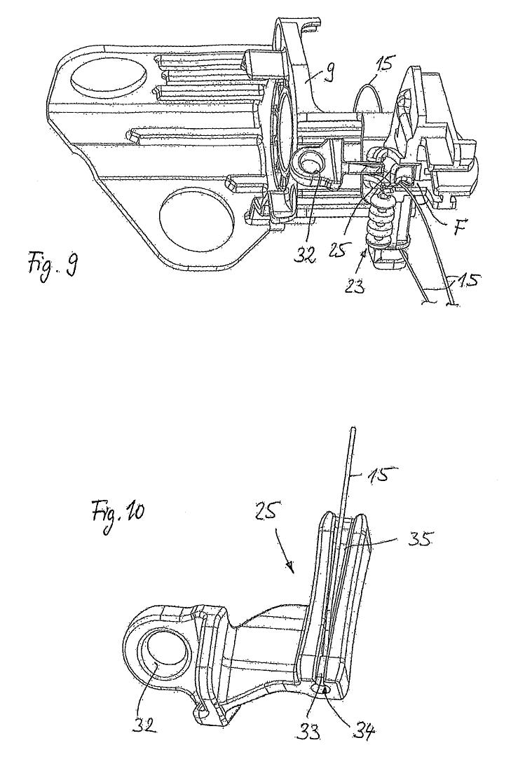

FIG. 9 shows a perspective view of a part of the shading device according to FIGS. 1 to 8 in the region of a sliding body guiding the pull-out profile; and

FIG. 10 shows an enlarged view of the sliding body according to FIG. 9 in a perspective view from below in the region of an engagement point of a cable end of the cable pull.

A protection device in the form of a shading device 1 according to FIGS. 1 to 10 is provided for shading a rear window of a passenger vehicle. The shading device 1 comprises a flexible planar structure 2, in the present case in the form of a textile knitted or woven fabric, which is held on a roller blind shaft 11 to be wound up and off between a pulled-out protective position, as shown in FIG. 1, and a wound-up rest position, as shown in FIG. 2. The roller blind shaft 11 is designed as a cylindrical hollow profile. The planar structure 2 and the winding shaft 11 are enclosed by a dimensionally stable, cartridge-type accommodation profile 4 over a major part of their longitudinal extension as seen in the longitudinal direction of the roller blind shaft 11.

In a ready-for-use functional condition, completely assembled to the vehicle, the roller blind shaft is disposed below a rear shelf (not illustrated) which is positioned in the vehicle interior below the rear window of the passenger vehicle. In the rear shelf, a passage slot is provided, through and across which the flexible planar structure 2 extends.

The planar structure 2 is connected to a dimensionally stable pull-out profile 3 on that face end region that is in front in the pull-out direction.

It is apparent with reference to FIGS. 2 and 3 that, for this purpose, the planar structure 2 is provided with a welting in the front face end region, which welting is inserted in a complementary welting groove of the pull-out profile 3 alongside the pull-out profile 3. In the wound-up rest position of the planar structure 2 the pull-out profile 3 is located in the region of an upper side of an edge of the passage slot resting on the rear shelf and covering the passage slot.

It is apparent with reference to FIGS. 1 to 3 that the roller blind shaft 11 is mounted on its opposite face ends in two casing arrangements 5, 9, 10; 9′, 10′, which will be described in more detail below, wherein, in the illustration according to FIG. 1, the left-hand side casing arrangement 5 represents a casing arrangement on the drive side and, in the illustration according to FIG. 3, the right-hand side casing arrangement 9′, 10′ represents a casing arrangement on the driven side. The two casing arrangements 5, 9, 10; 9′, 10′ are each connected to the cartridge-type accommodation profile 4 on a respective face end thereof. For that purpose, casing shell parts 9, 9′ of the casing arrangements include plug-in profilings (not illustrated in more detail) to be plugged-in on the respective open face end of the cartridge-type accommodation profile 4 in an accurately fitting manner. In addition, mechanical fixation elements, like screw or rivet connections, are provided (not illustrated in more detail), in order to secure the respective casing shell part 9, 9′ on the accommodation profile 4 in the plugged-on condition.

The two casing arrangements 5, 9, 10; 9′, 10′ are made of synthetic material and include integrally molded bearing and accommodation portions for further functional components, which will be described in more detail below.

The casing arrangement 5 on the drive side includes, in addition to the casing shell part 9 to be connected to the accommodation profile 4, a casing portion 10, adapted to be joined to the casing shell part 9 by means of screw connections or similar mechanical fixation means. The casing portion 10 has a holding recess (not illustrated in more detail) for fixation of an electric motor 8 which drives the roller blind shaft 11 in a manner that will be described in more detail below. A worm wheel 12 is fixed to a drive shaft of the electric motor 8, which worm wheel meshes with a toothed gear wheel 13 which is arranged coaxially in relation to a rotational axis of the roller blind shaft 11 and connected to the roller blind shaft 11 for conjoint rotation. The gear wheel 13 is embodied as a toothed spur gear wheel. The electric motor 8 is fixed to the casing portion 10 transversely in relation to the rotational axis of the roller blind shaft 11. The worm wheel 12 is positioned below the gear wheel 13 meshing in relation to the gear wheel 13, as is apparent with reference to FIGS. 4 and 5.

Torque transmission between the electric motor 8 and the roller blind shaft 11 occurs from the gear wheel 13 via an elastic plug-in coupling device 17, 18, clearly apparent with reference to FIGS. 4 and 6. The elastic plug-in coupling device includes an elastic coupling member 17 which is a one-piece elastomer body including corresponding, axially open plug-in profilings both towards the gear wheel 13 and towards a face end-sided terminal body 18. The face end-sided terminal body 18 is a face end-sided cover or closure for the roller blind shaft 11 and includes complementary, on the face end side axially outwards protruding plug-in profilings which plunge into the plug-in profilings of the elastic coupling member 17 for conjoint rotation. The gear wheel 13 includes, as is apparent with reference to FIG. 6, plug-in profilings axially extending towards the roller blind shaft 11 (not illustrated in more detail), which plunge into the plug-in profilings, configured as axial recesses, of the elastic coupling member 17 in a claw-type manner. Additionally, the gear wheel 13 is provided with a cylindrical ring flange, wherein the axial plug-in profilings are provided on the inner side thereof. The ring flange receives the coupling member 17 axially, as visible in FIG. 7. The connection between the gear wheel 13, the coupling member 17 and the face end-sided terminal body 18 is obtained by simple axial plugging-in of said functional parts. The gear wheel 13 is rotatably mounted in a bearing seat (not illustrated in more detail) of the casing arrangement 5, 9, 10.

The casing arrangement 5, 9, 10 is fixed to the accommodation profile 4 using vibration damping elements 21, merely one thereof illustrated in FIG. 2.

The electric motor 8 drives the roller blind shaft 11 about its rotational axis in both directions of rotation via the torque transmission means in the form of the worm wheel 12, the toothed gear wheel 13, the axial plug-in profilings, the elastic coupling member 17 and the face end-sided terminal body 18.

On an opposite face end the roller blind shaft 11 is provided with further torque transmission means which are in a mirror symmetrical manner likewise embodied by an elastic plug-in coupling device having a face end-sided terminal body 18, an elastic coupling member 17 and the axial plug-in profilings (not illustrated in more detail) of a support disk 29. All of the functional parts or portions of said opposite driven side of the roller blind shaft 11, indicated by the same reference numerals, have an identical design as compared to the corresponding functional parts of the above described drive side according to FIG. 2. Thus, to avoid repetitions, additional reference is made to the disclosure in relation to the drive-side functional parts.

It is apparent with reference to FIGS. 3 and 8 that the roller blind shaft 11 on the driven side is coupled to the support disk 29 for conjoint rotation for the sole reason that driving of a cable pull system on this driven side is ensured. An identical cable pull system is also associated with the drive side and will be described in more detail below. The support disk 29 is rotatably mounted between the casing shell part 9′ and the casing portion 10′, wherein the casing portion 10′ is connected to the casing shell part 9′ by means of screw connections or similar mechanical fixation means.

Both the casing portion 10 and the casing portion 10′ include a cylindrical annular shoulder protruding axially outwards relative to the roller blind shaft 11, with a respective cable drum 14 rotatably mounted on each thereof. Moreover, each casing portion includes a covering shield in the shape of a cylinder section enclosing the cable drum 14 over a major part of its circumference radially on the outside, which covering shield encloses the cable drum 14 radially on the outside in the circumferential direction. As a result, there is an annular space 30 (FIG. 4) produced between the covering shield and the inner-sided annular shoulder, wherein the cable drum 14 is rotatably mounted. The respective cable drum 14 is mounted for free rotation in the respective casing arrangement 5, 9, 10; 9′, 10′. Coupling of the respective cable drum 14 to the roller blind shaft 11 is obtained by interposing a torsion spring 16 acting as a cable length compensation unit, which is embodied in a helical leg spring. One leg end of the torsion spring 16 is connected to the cable drum 14 for conjoint rotation. An opposite leg end of the helical torsion spring 16 is connected to a support ring 19 of the gear wheel 13 and the support disk 29, respectively, for conjoint rotation. The respective support ring 19 is integrally molded to the gear wheel 13 and the support disk 29, respectively. Using an axial lock washer 20 and a screw (not illustrated in more detail), the respective torsion spring 16 is axially fixed to the support ring 19 of the gear wheel 13 and the support disk 29, respectively.

On each cable drum 14 is held a respective cable end of a respective open cable 15. The cable end is fixed to a corresponding holder on an outer circumference of the respective cable drum 14 such that the cable cannot disengage from the cable drum 14 during operation of the shading device.

Each casing shell part 9, 9′ includes an integrally molded tab 22 for pivotable retaining of a guiding structure 6, 7. Said guiding structures 6 and 7 are fixed to the vehicle in the completely assembled, ready-for-use condition of the shading device 1, 1a. The vehicle-related fixation is along the C-pillar portions of a vehicle body support structure of the passenger vehicle. Each guiding structure 6, 7 has a two-part design and includes a respective outer side functional profile and an inner side lining cover 24, as seen relative to a center of the vehicle interior, which are matched to corresponding lining parts of the vehicle interior. The lining cover 24 and the functional profile are joined together after completed assembly of the respective functional profile to the vehicle. The two functional profiles of the opposite lateral guiding structures 6, 7 are mirror symmetrical, however, for the rest have an identical design. Each functional profile is pivotably connected to the tab 22 of the casing shell part 9 via a respective hinge arrangement 23. The hinge arrangement 23 comprises hinge profilings and guiding and travel limiting means, each integrally molded to the functional profile or the tab 22. The functional profiles—like the casing shell parts 9—are one-piece components each made of a thermoplastic synthetic material.

The two guiding structures 6, 7 are used for longitudinal displacement of the pull-out profile 3. For that purpose, the pull-out profile 3 is provided, on each of its opposite face ends, with a respective seat 28 for retaining a sliding body 25. The pull-out profile 3 has a telescopic design such that the retaining seats 28 are provided on lateral parts of the pull-out profile 3, which are lengthwise displaceable relative to a dimensionally stable central part of the pull-out profile 3 in the transverse direction of the vehicle and, thus, transversely to a pull-out direction of the planar structure 2, so that the pull-out profile 3 is telescopically operable. The sliding body 25 has an accommodation eye (not illustrated in more detail in FIGS. 2 and 3) which is inserted into the retaining seat 28. Fixing of the sliding body 25 to the face end of the pull-out profile 3 is by a socket pin 27 of a cover part 26 of the pull-out profile 3, said pin penetrating the accommodation eye in the assembled condition.

The sliding body 25 comprises an elongate sliding block which is guided for longitudinal shifting in a guiding groove serving as guiding track (not illustrated in more detail) of the respective functional profile of both the guiding structures 6, 7. In the respective functional profile, the cable 15 of the cable pull is guided in a distinct guiding track, deflected by 180° on a face end region of the respective functional profile remote from the tab 22 and the hinge arrangement 23, and guided through the guiding groove for the sliding body 25 up to the sliding block of the sliding body 25. A free cable end of the cable 15 is fixed to the sliding block of the sliding body 25. This description applies both to the drive side and to the driven side. Thus, an entire closed drive system is obtained.

Pivoting mobility of the functional profile relative to the tab 22 and the respective casing shell part 9, 9′ is available only prior to and during an assembling procedure of the shading device in the passenger vehicle. After assembly of the respective functional profile fixed to the vehicle on vehicle-related body support structure regions, in particular in the region of C-pillar portions, the respective functional profile is fixed to the vehicle so that pivoting mobility is no longer available. After completed ready-for-use assembly of the shading device 1 in the vehicle interior, driving of the electric motor 8 causes rotation of the roller blind shaft 11 and simultaneous and synchronous rotation of both cable drums 14 of the cable pulls on the drive side and the driven side, whereby the sliding bodies 25 are displaced in synchronization lengthwise the guiding grooves of the opposite functional profiles. Thereby, the pull-out profile 3 can be displaced between the wound-up rest position of the planar structure 2 and the pulled-out protective position of the planar structure 2, as needed. The torsion springs 16 in the opposite sides of the drive system compensate differences in cable tension or different tensions of the planar structure 2 so that a closed and self-adjusting drive system is obtained. The electric motor 8 can be designed with a very low performance, since owing to the absence of a winding spring, which would be associated with the roller blind shaft 11, there is no need for great driving forces. Moreover, driving forces of approximately equal amount are needed for deploying of the pull-out profile 3 from the rest position to the protective position and for retracting the pull-out profile 3 from the protective position to the rest position.

Each of the two guiding structures 6 and 7 has a two-part design, composed of a functional profile, not illustrated in more detail, and a lining cover 24 which is flush with a vehicle interior lining in the assembled functional condition of the shading device 1. The two functional profiles of the guiding structures 6 and 7 are mirror symmetrical, however, for the rest have an identical design. Each functional profile has an integral guiding groove for linear shifting of the respective sliding body 25. Additionally, each functional profile is provided for guiding and deflecting of the cable 15 of the respective cable pull. Thereby, the cable 15 is initially guided along an outer side of the functional profile opposite to the guiding groove F, subsequently deflected on a face end region of the functional profile remote from the casing arrangement 5 via a deflection guide 31, and then returned through the guiding groove F up to the sliding body 25.

It is apparent with reference to FIGS. 4 to 6 that the respective functional profile of the guiding structure 6 or 7 extends starting from the casing arrangement 5 within the vehicle interior compartment obliquely upwards, in the assembled functional condition. It is apparent with reference to FIG. 6 that the cable 15 is pulled off the cable drum 14 in the region of a bottom side of the cable drum 14 and guided over a plurality of guiding elements 30 along the outer side of the functional profile (FIG. 7). In that context, a plurality of guiding elements 30 are embodied in transverse clamp supports which exert a transverse tension on the cable 15, in order to prevent a vibrating guitar strings effect of the cable 15 during operation of the shading device 1. Both the guiding elements 30 and the guiding groove F are integrally molded to the functional profile of the guiding structure 6, 7 made of thermoplastic synthetic material, preferably using an injection molding procedure. The guiding groove F has an arched curvature towards a vehicle center, in order to allow working of the cable 15 during functional operation.

It is apparent with reference to FIG. 9 that the sliding body 25 is guided for linear movement in the guiding groove F by a cuboid sliding block extending along the guiding groove F. The guiding groove F forms a channel enclosing the sliding block of the sliding body 25. The guiding groove F is open towards the center of the vehicle interior and, thus, towards the lining cover 24 which likewise has an open design complementary to the guiding groove F by means of a longitudinal slot (not illustrated in more detail) which retraces the guiding groove F. Each sliding body 25 includes a cross web protruding from the sliding block inwards to a center of the vehicle interior, which web protrudes through the open side of the guiding groove F and through the longitudinal slot of the lining cover 24 inwards to a center of the vehicle interior. The cross web is integrally molded to the sliding block. An eye 32 on the cross web is integrally continued towards the interior, which eye has a crossed configuration in relation to the plane of the cross web and the sliding plane of the sliding block. The eye 32, also referred to as an accommodation eye, is for accommodating the socket pin 27 of the cover part of the pull-out profile 3, in order to secure the sliding body 25 in the seat 28 of the face end of the pull-out profile 3.

It is apparent with reference to FIG. 2 and with reference to FIG. 3 that the planar structure 2 with its transversely extending welting engages in the welting groove of the pull-out profile 3 in the region of a bottom side of the pull-out profile 3. Thereby, owing to a permanent slight tensional loading of the planar structure 2, a tilting effect acts, necessarily, on each sliding body 25, which could cause twisting of the sliding block of the sliding body 25 in the guiding groove F. As a result thereof, sliding friction of the sliding body 25 within the guiding groove F of the functional profile would be increased, whereby a required tensional force of the cable 15 would, necessarily, increase as well.

In order to allow compensation of said tilting effect, one cable end 33 of the cable 15 is guided along in a groove 35 in the region of a bottom side of the sliding block and secured in a recess 34 of the sliding block in a form-fitting manner (FIG. 10). Thus, the cable end 33 of the cable 15 engages the sliding body 25 eccentrically in relation to an imaginary tilting axis such that a counter-torque is exerted on the sliding body 25 by the tensional force of the cable 15, which force is introduced into the recess 34 of the downward open groove 35 of the sliding block via the cable end 33. Due to said counter-torque counteracting the tilting effect, which is exerted on the pull-out profile 3 by the tensional force of the planar structure 2, the respective sliding body 25 is equilibrated at least largely within the guiding groove F such that twisting or tilting of the sliding block in the guiding groove F can be prevented. As a result, sliding friction between the guiding groove F and the sliding block of the respective sliding body 25 within the functional profile is reduced so that the respective cable 15 also has to exert a minor tensional force to displace the sliding block of the respective sliding body 25 within the functional profile. The side walls of the groove 35 do not extend in parallel to each other, in order to allow room for movements of the cable 15.

The deflection guide 31, as illustrated with reference to FIG. 8, on an upper face end region of the functional profile of the guiding structure 6 has a circular arc shape and is configured as a mere sliding guide. Surprisingly, it was found during constructional design that a circular arc-shaped sliding guide allows to achieve deflection of the cable 15 with similar low friction as with a cable pulley positioned in said region. In a not illustrated embodiment, a cable pulley is provided instead of the circular arc-shaped sliding guide. The sliding guide designed merely as a sliding guide and formable together with the production of the functional profile is obtainable in a substantially more cost-efficient and easy to manufacture way, as compared to a cable pulley. The circular arc-shaped deflection guide 31 has a semicircular arc. In the exemplary embodiment as illustrated in FIG. 8, one half of the circular arc-shaped deflection guide 31, as seen in the longitudinal direction, is integrally molded to the functional profile of the guiding structure 6, 7, whereas the other half, constituting the second half of the trench-type, circular arc-shaped groove, is created by a separate component which is likewise made of synthetic material and fixable by plugging or interlocking in the region of the deflection guide 31.

1. Protection device for a vehicle interior compartment, comprising a flexible planar structure which is displaceable between a pulled-out protective position and a rest position, wherein the planar structure is connected to a dimensionally stable pull-out profile on a face end region that is in front in the pull-out direction, which profile is mounted for longitudinal displacement on each of its opposite sides in a respective guiding structure disposed fixed to the vehicle in the ready-for-use condition, wherein a respective cable pull is installed in each guiding structure, each cable pull engaging on a respective one of sliding bodies slidingly mounted in the guiding structure, which sliding body is connected to the pull-out profile such that a torque introduced into the pull-out profile by a point of application of the cable pull on the sliding body and a counter-torque introduced into the pull-out profile by the planar structure are configured, relative to a longitudinal axis of the pull-out profile extending transversely to the pull-out direction, such that the sliding bodies and the pull-out profile are held in equilibrium during a displacement move.

2. Protection device according to claim 1, wherein the cable pull includes an open cable which is connected to the sliding body on one end thereof and to a rotatable cable drum on an opposite end thereof.

3. Protection device according to claim 1, wherein each cable pull is associated with a cable length compensation unit.

4. Protection device according to claim 1, each guiding structure is provided, on its end region remote from the cable drum, with a deflection guide designed in the form of a circular arc-shaped sliding guide for the cable.

5. Protection device according to claim 1, wherein the cable is guided along the guiding structure over a plurality of transverse clamp supports which cause combined guiding and transverse clamping of the cable relative to the running direction thereof.
